(19) United States
(12) Patent Application Publication
(10) Pub. No.: US 2006/0006791 A1
(43) Pub. Date: Jan. 12, 2006

(54) Light emitting diode display that does not require epoxy encapsulation of the light emitting diode

(76) Inventors: Chee Wai Chia, Penang (MY); Kee Yean Ng, Penang (MY); Heng Yow Cheng, Penang (MY)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/886,170

(22) Filed: Jul. 6, 2004

(51) Int. Cl. H01J 1/62

(52) U.S. Cl. 313/498

(57) ABSTRACT

A display having a cover element that is fastened to a base element is disclosed. The base element includes a substrate having a die with a semiconductor light source. The die is covered by a transparent protective layer. The cover element includes an opaque layer having an opening positioned to allow the die and the protective layer to protrude through the opening in the bottom surface but remain below the level of the top surface. A transparent window covers the opening above the die and the protective layer. The transparent window defines a pattern that is illuminated by the light source and visible from above the top surface of the cover element. A fastener affixes the base element to the cover element. The opaque layer and transparent window can be made in a two-step molding process. The display avoids the problems associated with encapsulating LEDs in an epoxy.

### BACKGROUND OF THE INVENTION

Light-emitting diodes(LEDs) have significant advantages over incandescent and fluorescent light sources both in terms of life time and light output per unit of electricity consumed. Hence, there is a significant incentive to move this technology from simple status indicators on electronic devices to more complex displays that require light sources having geometries that are significantly different from the simple point sources utilized in status indicators.

Consider a seven-segment display of the type utilized to display numbers on control panels and the like. The display may be viewed as 7 elongated segments that emit light when turned on. By turning on these segments in various combinations, the numbers from 0 to 9 as well as some other characters can be displayed. While linear incandescent sources are easily constructed by utilizing an extended filament in the light source, LEDs are typically limited to point sources. Hence, to implement such a display with an LED, the LED must be mounted in an optical housing that converts the LED point light source into a bar-shaped light source.

Extended LED displays are typically implemented by mounting the LED in the bottom of a cavity or well that has a region with a cross-section having the desired shape. The LED is positioned such that light from the LED illuminates the region in question. The well is then filled with a transparent epoxy. A light diffuser can be incorporated in the epoxy or placed between the viewer and the region in question to spread the light so as to form a more uniformly illuminated display segment.

The epoxy encapsulating material imposes design limitations that can substantially increase the cost of a display, or alternatively, limit the lifetime of the display. The epoxy must be compatible with the LED die and the material in which the cavity is formed. In addition, the epoxy must withstand the operating temperatures imposed both by the LED itself and the environment in which the final light source is to operate.

In addition, the epoxy encapsulation process is a lengthy process that increases the manufacturing costs. To assure that the final encapsulation is clear and free from bubbles, the process requires that the components be degassed in vacuum, that the underlying printed circuit board have sufficient holes to allow any entrapped air or bubbles to be removed, and that the epoxy curing be done in an environment that assures that the epoxy is properly cured. If the epoxy is under cured, thermal instabilities in the material that cause in-field failures can occur. If the epoxy is over cured, the material can become very brittle and may crack under thermal cycling either during the testing phase of the manufacturing process or during the utilization of the device in the field. In addition, the inexpensive epoxies that are commonly used are moisture-sensitive materials that have hygroscopic characteristics. The material absorbs moisture over time. Material that is under cured is particularly vulnerable to this type of problem. The absorbed moisture can result in optical defects that appear during processing steps that subject the displays to high temperatures such as wave soldering. In addition, the moisture can cause long-term aging effects that limit the lifetime of the displays.

Furthermore, the epoxy materials can expand or contract significantly during the curing process. This can lead to warping of the display unless materials that resist the warping are utilized. These stronger materials increase the cost of the displays. It should also be noted that these epoxies have different thermal coefficients of expansion than the surrounding materials, and hence, can lead to warping or epoxy separation during the operation of the displays if high power LEDs are utilized in the display.

Finally, it should be noted that the epoxy encapsulation process is irreversible. A typical display includes a large number of LEDs and light shaping elements. All of the LEDs are encapsulated at the same time. If one of the LED display elements has a defect such as entrapped bubbles or a defective LED die, the display cannot be repaired by replacing the defective component, and hence, the entire display must be discarded. The failure probability increases with the number of LEDs, and hence, the yield of devices on the fabrication line can be significantly reduced for displays having large numbers of display segments.

### SUMMARY OF THE INVENTION

The present invention includes a display having a cover element that is fastened to a base element. The base element includes a substrate having a die mounted thereon, the die includes a semiconductor light source. A transparent protective layer covers the die. The cover element includes an opaque layer having a top surface and a bottom surface. The opaque layer includes an opening extending from the bottom surface to the top surface. The opening is positioned to allow the die and the protective layer to protrude through the opening in the bottom surface. The cover element further includes a transparent window covering the opening above the die and the protective layer. The transparent window defines a pattern that is illuminated by the light source and visible from above the top surface of the cover element. A fastener affixes the base element to the cover element such that the die protrudes through the opening in the bottom surface. In one embodiment, the opaque layer includes a molded plastic element of a first plastic having a first melting point, and the transparent window includes a molded plastic element of a second plastic having a second melting point, the second melting point is less than the first melting point. In one embodiment, the opaque layer and the transparent window are connected to one another by a protrusion that extends from one of the opaque layer and the transparent window into the other of the opaque layer and the transparent window. In one embodiment, the fastener includes a latch that is affixed to either the cover element or the base element, the latch engaging the other of the base element or the cover element. In one embodiment, the transparent window includes an optical element for imaging the light source. In one embodiment, the transparent protective layer includes a pliable material. In one embodiment, the transparent window includes a light guide that contacts the pliable material.

### BRIEF DESCRIPTION OF THE DRAWINGS

FIG. 1 is a top view of prior art display element 10.

FIG. 2 is a cross-sectional view of prior art display element 10 through 2-2′.

FIG. 3 is a cross-sectional view of a display segment according to one embodiment of the present invention.

FIG. 4 is a cross-sectional view of a portion of a display 50 according to an embodiment of the present invention that incorporates a lens in the window of the cover element.

FIG. 5 is a cross-sectional view of a portion of a display 60 in which the light guide of the window presses against and deforms the protective layer surrounding the die.

### DETAILED DESCRIPTION OF PREFERRED EMBODIMENTS OF THE INVENTION

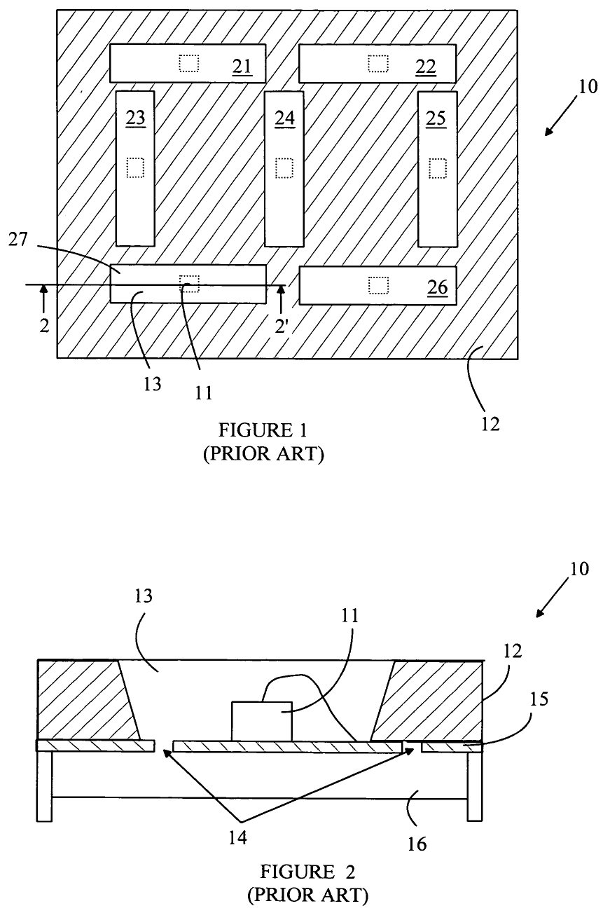

The manner in which the present invention provides its advantages can be more easily understood with reference to FIGS. 1 and 2, which illustrate a prior art 7-segment display element. FIG. 1 is a top view of prior art display element 10, and FIG. 2 is a cross-sectional view of prior art display element 10 through 2-2′. Display element 10 has 7 display segments 21-27 that appear as illuminated bars when lit. Each display segment utilizes an LED on a die 11 to generate the light that illuminates that segment. To simplify the following discussion, it will be assumed that a single LED is utilized; however, the individual segments can have multiple LEDs. The individual dies are mounted on a base element that includes a printed circuit board 15. The details of the mounting of die 11 are shown more clearly in FIG. 2. Die 11 is mounted on a substrate 15 such as a printed circuit board by any of a number of bonding techniques. Printed circuit board 15 also includes the dies that are part of other display segments 21-26. In addition, printed circuit board 15 can include other control circuitry that selects which of the segments is illuminated at any given time. An opaque substrate 12 having openings that define the shape of the display segments is mounted on top of printed circuit board 15. The opening corresponding to display segment 27 is shown at 13. Opening 13 defines the shape of the final illuminated display element. Opening 13 forms a cavity in substrate 12 that is deeper than the thickness of die 11. This cavity is filled with epoxy as described above. A number of vias or holes 14 are placed in printed circuit board 15 to provide channels for removing any bubbles that form or are trapped during the epoxy deposition process. A layer 16 of epoxy is also applied to the underside of printed circuit board 15 to seal the structure including these holes.

FIG. 1 only shows one 7-segment display; however, a typical display can have many such displays as well as displays having different shapes. For example, a display that presents a multi-digit number would have one 7-segement display per digit. The additional segments are constructed on the same printed circuit board and utilize other wells located in substrate 12. As noted above, the epoxy fill in opening 13 causes numerous problems that increase the cost of the display and/or reduce the display lifetime and production yield. The present invention avoids these problems by utilizing an arrangement that does not require this epoxy encapsulation process.

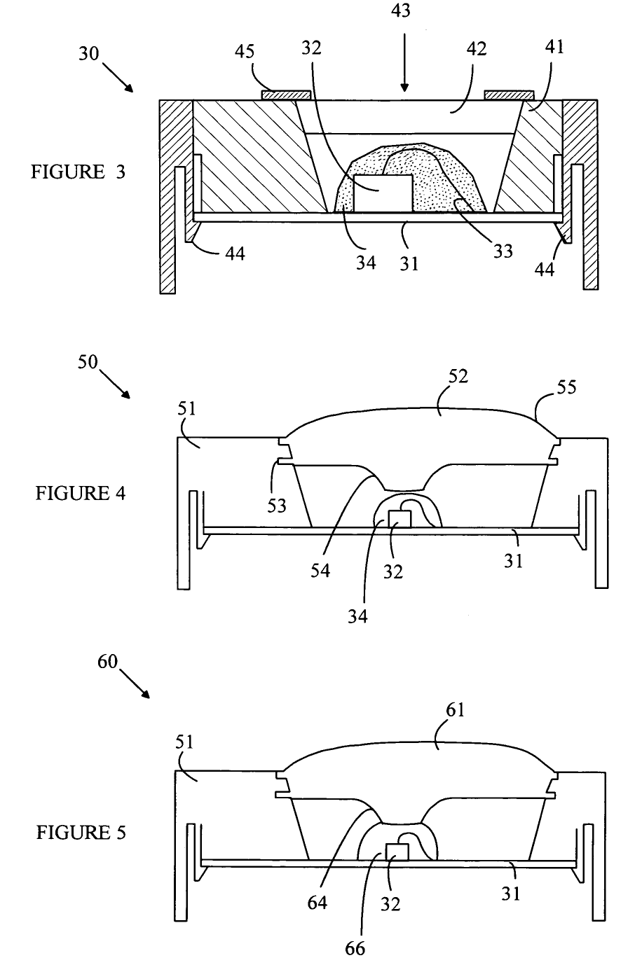

Refer now to FIG. 3, which is a cross-sectional view of a display segment according to one embodiment of the present invention. Display 30 is constructed from two components that are clipped together after the components have been fabricated. The first component is a base component that includes a printed circuit board 31 having an LED die 32 attached thereto. The leads to the LED are connected to corresponding terminals on printed circuit board 31 either under the die or via a connecting wire such as wire 33. The die is covered by clear silicone layer 34 to protect the die.

The second component is a cover element that includes an opaque substrate 41 that includes a hole 43 that defines the maximum size of the segment. A transparent window 42 covers the hole 43 in opaque substrate 41 and is sealed to opaque substrate 41 by virtue of the manufacturing methodology discussed below. In the embodiment shown in FIG. 3, the second component is connected to printed circuit board 31 mechanically using the clips shown at 44. These clips are attached to substrate 41 in this embodiment of the invention.

The shape of the display segment can be defined by hole 43 or by a pattern that is added to the top surface of window 42. If the clear window is partially covered by an opaque layer as shown at 45, the segment will take on the shape defined by the clear portion of the pattern created by the opaque layer. Such embodiments have the advantage of allowing the final segment shape to be determined after the individual light sources have been constructed by depositing an opaque layer using lithographic methods to the completed light source. Hence, one light source can be utilized for a variety of displays.

Alternatively, hole 43 can be constructed with a cross-section that provides the desired shape. If the placement of the segments is unique to the display in question, little is gained by adding the display shape after the underlying base element has been assembled, since the underlying base element cannot be used for other displays.

The present invention separates the shape defining functions of the cover element from the die protecting functions. Since the die is sealed by layer 34, the opaque substrate and segment window 42 do not need to be hermetically sealed over the die to protect the die. Furthermore, the substrate and window can be removed to access the die in the event the die must be replaced. In addition, the warping problems discussed above are eliminated.

The cover element is preferably constructed via a two-step molding process. Substrate 41 is molded in the first step from a plastic that is opaque and that has a relatively high melting point. In the second molding step, the transparent window 42 is molded into substrate 41 using a plastic with a significantly lower melting temperature. This lower melting temperature allows the window to be molded into substrate 41 without distorting the pre-molded substrate. Substrate 41 can be rendered opaque by using an appropriate plastic or by incorporating a material such as TiO₂ in the plastic to absorb any light that enters substrate 41. Any suitable plastic can be utilized for substrate 41. For example, substrate 41 can be constructed from polycarbonate, ABS, polycarbonate and acrylonitrile/butadiene/styrene, polybutylene terephthalate, liquid crystal polymer, Polyphtalamide or other plastics having suitable melting temperatures. The choice of material will, in general, depend on the particular design and application.

The window shown at 42 can likewise be constructed of any plastic that has a suitable melting temperature and which is transparent to the light from the LED. Once again polycarbonate or ABS plastics can be utilized. The plastic used for the windows may include a diffusing material, a coloring agent, phosphor particles for converting a portion of the LED light to another wavelength, etc.

Embodiments of the present invention that utilize a window that also includes optical elements for imaging the light from the LED can also be constructed. Since the window is molded in a separate fabrication operation from a material that is different from the opaque portion of the cover element, the present invention can utilize a wide variety of optical elements. For example, the window can include a collimating lens or a plurality of lenses over different portions of the window. In addition, optical elements based on stamped diffraction gratings can be incorporated in the windows.

Refer now to FIG. 4, which is a cross-sectional view of a portion of a display according to an embodiment of the present invention that incorporates a lens in the window of the cover element. Display 50 includes a die 32 mounted on a printed circuit board 31. The die is covered by a protective layer 34 of transparent material such as silicone. The cover element includes an opaque substrate 51 having a window 52 that is molded to provide a lens surface 55. Window 52 can also include other optical features such as the light guide shown at 54. In addition, opaque substrate 51 can include detents such as shown at 53 that prevent lens 52 from separating from substrate 51 during temperature cycling.

In the embodiment shown in FIG. 4, the light guide does not contact the protective layer. However, embodiments in which a pliable protective layer is utilized and light guide 54 presses against that layer can be constructed. Refer now to FIG. 5, which is a cross-sectional view of a portion of a display 60 in which the light guide 64 of window 61 presses against and deforms the protective layer 66 surrounding die 32. If the material used for the protective layer does not wet the surface of light guide 64, a coating of an appropriate wetting agent can be applied to light guide 64 or the surface of protective layer 66 to reduce reflections at this interface. The arrangement shown in FIG. 5 provides for an improved optical match between window 61 and die 32. In addition, by utilizing a pliable material such as silicon rubber for the protective layer, variations in the height of the protective layer above the printed circuit board can be accommodated, and hence, a high degree of precision in applying protective layer 66 is not required.

Since the present invention utilizes a cover element that is fabricated in a manner that does not subject the die to the fabrication process, the cover element can be fabricated using temperatures, molding conditions, and solvents that could damage the die. In contrast, the prior art epoxy-based encapsulation methods are limited to conditions and chemicals that are compatible with the die.

In addition, the cover elements can be molded in sheets having a large number of separate cover elements that are then separated after the molding operations into the individual cover elements. As a result, significant economies of scale can be achieved through mass production techniques. In contrast, the prior art methodology is limited by the need to individually dispense epoxy in precise quantities under carefully controlled conditions. The cost of this prior art encapsulation procedure substantially increases the cost of the resulting displays.

The above-described embodiments of the present invention utilize only a single die within each segment of the display. However, embodiments having multiple dies can also be constructed. Such embodiments provide more uniform light output across the segment in the display. In addition, display segments having arbitrary colors can be fabricated utilizing conventional RGB LEDs as the light source.

The embodiments of the present invention described above utilize a mechanical clip mechanism for securing the cover element to the printed circuit board having the LEDs that illuminate the various display segments and features. However, other methods of attaching the cover element to the printed circuit board can be utilized. For example, the cover element can be bonded to the printed circuit board utilizing a glue layer or can be attached using screws or other forms of fasteners.

The above-described embodiments of the present invention have utilized a source layer that includes a printed circuit board to which the dies are connected. However, other substrates can be used for mounting the dies. In principle, any substrate to which the cover element can be affixed and which acts as a mounting platform for the dies can be utilized.

The exemplary embodiments of the present invention described above have been directed to displays that utilize display segments that are simple rectangles. However, many other shapes of display segments can be utilized. Any shape that can be illuminated by placing one or more LED under the transparent window can be utilized. For example, display segments that include words or logos can be constructed in a manner analogous to that described above for the simple rectangular shapes. Hence, as used herein, the term display segment includes any geometric pattern that acts as a light source.

The above-described embodiments of the present invention have utilized an arrangement in which the transparent window is molded into the cover after the cover is formed. In this case, the window must be made of a plastic having a lower melting point than that of the cover. However, embodiments in which the window is formed first, and then the cover is molded around the window can also be practiced. In this case, the window needs to have the higher melting point.

Various modifications to the present invention will become apparent to those skilled in the art from the foregoing description and accompanying drawings. Accordingly, the present invention is to be limited solely by the scope of the following claims.

1. A display comprising:
a base element comprising a substrate having a die mounted thereon, said die comprising a semiconductor light source, said die being covered by a transparent protective layer that extends above said die to a height;
a cover element comprising an opaque layer having a top surface and a bottom surface, said opaque layer comprising an opening extending from said bottom surface to said top surface, said opening being positioned to allow said die and said protective layer to protrude through said opening in said bottom surface, said hole having a depth greater than said height, said cover element further comprising a transparent window covering said opening above said die and said protective layer, said transparent window defining a pattern that is illuminated by said light source and visible from above said top surface of said cover element; and
a fastener that affixes said base element to said cover element such that said die protrudes through said opening in said bottom surface, wherein said protective layer has dimensions such that said protective layer will pass through said opening in said bottom surface.

2. The display of claim 1 wherein said opaque layer comprises a molded plastic element of a first plastic having a first melting point and said transparent window comprises a molded plastic element of a second plastic having a second melting point, said second melting point being different from said first melting point, said one of said opaque layer and said transparent window having the lowest melting point being molded into the other of said opaque layer and said transparent window.

3. A display comprising:
a base element comprising a substrate having a die mounted thereon, said die comprising a semiconductor light source, said die being covered by a transparent protective layer that extends above said die to a height;
a cover element comprising an opaque layer having a too surface and a bottom surface, said opaque layer comprising an opening extending from said bottom surface to said top surface, said opening being positioned to allow said die and said protective layer to protrude through said opening in said bottom surface, said hole having a depth greater than said height, said cover element further comprising a transparent window covering said opening above said die and said protective layer, said transparent window defining a pattern that is illuminated by said light source and visible from above said top surface of said cover element; and
a fastener that affixes said base element to said cover element such that said die protrudes through said opening in said bottom surface,
wherein said opaque layer and said transparent window being connected to one another by a protrusion that extends from one of said opaque layer and said transparent window into the other of said opaque layer and said transparent window.

4. A display comprising:
a base element comprising a substrate having a die mounted thereon, said die comprising a semiconductor light source, said die being covered by a transparent protective layer that extends above said die to a height;
a cover element comprising an opaque layer having a top surface and a bottom surface, said opaque layer comprising an opening extending from said bottom surface to said top surface, said opening being positioned to allow said die and said protective layer to protrude through said opening in said bottom surface, said hole having a depth greater than said height, said cover element further comprising a transparent window covering said opening above said die and said protective layer, said transparent window defining a pattern that is illuminated by said light source and visible from above said to surface of said cover element; and
a fastener that affixes said base element to said cover element such that said die protrudes through said opening in said bottom surface,
wherein said fastener comprises a latch that is affixed to either said cover element or said base element, said latch engaging the other of said base element or said cover element.

5. A display comprising:
a base element comprising a substrate having a die mounted thereon, said die comprising a semiconductor light source, said die being covered by a transparent protective layer that extends above said die to a height;
a cover element comprising an opaque layer having a top surface and a bottom surface, said opaque layer comprising an opening extending from said bottom surface to said top surface, said opening being positioned to allow said die and said protective layer to protrude through said opening in said bottom surface, said hole having a depth greater than said height, said cover element further comprising a transparent window covering said opening above said die and said protective layer, said transparent window defining a pattern that is illuminated by said light source and visible from above said top surface of said cover element; and
a fastener that affixes said base element to said cover element such that said die protrudes through said opening in said bottom surface.
wherein said Transparent window comprises an optical element for imaging said light source.

6. The display of claim 1 wherein said transparent protective layer comprises a pliable material.

7. The display of claim 6 wherein said transparent window comprises a light guide that contacts said pliable material.

8. The display of claim 6 wherein said pliable material comprises silicone.

9. A method for fabricating a display comprising:
fabricating a base element comprising a substrate having a die mounted thereon, said die comprising a semiconductor light source, said die being covered by a transparent protective layer that extends above said die to a height;
fabricating a cover element comprising an opaque layer having a top surface and a bottom surface, said opaque layer comprising an opening extending from said bottom surface to said top surface, said opening being positioned to allow said die and said protective layer to protrude through said opening in said bottom surface, said hole having a depth greater than said height, said cover element further comprising a transparent window covering said opening above said die and said protective layer, said transparent window defining a pattern that is illuminated by said light source and visible from above said top surface of said cover element; and
affixing said cover element to said base element after said base element and cover element have been fabricated with a fastener such that said die protrudes through said opening in said bottom surface.

10. The method of claim 9 wherein said cover element is fabricated by molding one of said opaque layer and said transparent window and
molding the other of said opaque layer and transparent window onto that opaque layer or transparent window.
